(19) United States
(12) Patent Application Publication
(10) Pub. No.: US 2013/0174517 A1
(43) Pub. Date: Jul. 11, 2013

(54) Carpet Recycling Method

(71) Applicant: Environmental Recycled Carpet Systems, LLC, Sweetwater, TN (US)

(72) Inventors: David Kelley, Knoxville, TX (US); Paul Ashman, North Reading, MA (US)

(73) Assignee: Environmental Recycled Carpet Systems, LLC, Sweetwater, TN (US)

(21) Appl. No.: 13/739,426

(22) Filed: Jan. 11, 2013

Related U.S. Application Data
(60) Provisional application No. 61/585,270, filed on Jan. 11, 2012.

(51) Int. Cl. B02C 23/00; B02C 18/16

(52) U.S. Cl. CPC B02C 23/00; B02C 18/16
USPC 53/399; 241/21; 53/435

(57) ABSTRACT

A carpet recycling method is disclosed. In a toroidal flow pulper, carpet is disintegrated in a quantity of liquid to form a slurry of fibrous carpet materials and carpet ash. At least a portion of the fibrous carpet materials are separated from the slurry, and the separated fibrous carpet materials are dried. At least a portion of the carpet ash is isolated from the slurry, and the isolated carpet ash is dried. Thus, a first output comprising dried separated fibrous carpet materials is produced, and a second output comprising dried carpet ash is produced.

### CROSS-REFERENCE TO RELATED APPLICATIONS

This application claims the benefit of U.S. Provisional Patent Application No. 61/585,270, filed on Jan. 11, 2012, which is incorporated herein by reference.

### STATEMENT REGARDING FEDERALLY-SPONSORED RESEARCH OR DEVELOPMENT

Not Applicable

### BACKGROUND OF THE INVENTION

1. Field of Invention

The invention relates to methods and processes useful in recycling carpet. More particularly, this invention relates to methods and processes whereby carpet is reduced into component materials by separating carpet fibers in the carpet from calcium carbonate that forms the backing material of the carpet.

2. Description of the Related Art

The concept of recycling and reclaiming waste materials and refuse for use in starting material for new products is well known. Environmental concerns and landfill regulations have placed an increasing emphasis on the need to recycle and decrease waste in the manufacturing of goods and products. Furthermore, manufacturing processes that utilize recycled goods can also decrease manufacturing costs, thereby lowering the price of the goods.

There is a growing awareness of the need to reclaim raw materials from used carpets for use as starting materials in numerous industries. According to the Carpet America Recovery Effort's 2010 Annual Report statistics, over six (6) billion pounds of carpet were discarded in 2010. Of those six (6) billion pounds of discarded carpet, less than one (1) billion pounds were recycled. Over four and one-half (4½) billion pounds were placed in landfills. Accordingly, there is a continuing need for new efficient and convenient methods and devices for recycling carpet.

Generally, carpets comprise fibrous materials and backing materials which may be separated and harvested for reintroduction into carpeting as starting material. More specifically, many modern carpets comprise fibers which are fabricated from nylon, polypropylene, polyethylene tetraphthalate (PET), or other such materials, together with a backing which usually includes polypropylene, calcium carbonate, and latex glue. In the field of recycling carpet, emphasis is placed on reclaiming nylon fibers from carpet due to the relative cost of nylon in comparison to the other materials discussed above. However, in order to reclaim nylon from carpet such that the reclaimed nylon may be used in the manufacture of new carpet, the nylon must be separated from the backing materials to which it is typically adhered.

Several carpet recycling processes are well known in the art. For instance, one method of recycling carpet includes sending the carpet through a machine which shaves nylon fibers from the backing material in the carpet. However, this method typically results in reclamation of only that portion of the nylon fibers in the carpet which protrude beyond a threshold distance from the backing material. Thus, a significant percentage of the nylon fibers in the carpet must be discarded along with the backing material.

U.S. Pat. No. 7,635,099 issued to Meredith et al. teaches another method of recycling carpet, whereby carpet pieces are shredded, screened to separate fibrous materials from backing materials, and then introduced into a liquid slurry and centrifuged. However, the method disclosed in Meredith et al. is limited in its ability to separate calcium carbonate in the backing material of carpet from nylon fibers in the carpet. Furthermore, none of the known processes are capable of immediate breakdown and recycling of wet carpet. This presents an issue when, for instance, a carpeted building is flooded and replacement of carpet in the flooded building and recycling of the wet carpet is desired. The carpet in the flooded building becomes wet, and is therefore no longer capable of being recycled through known processes. Thus, instead of the carpet's components being recycled and reclaimed for use as starting material, the wet carpet rolls are often placed in a landfill.

In light of the above, there is a need in the art for a carpet recycling process that is capable of receiving either wet or dry carpet rolls and separating the carpet fibers from the backing material for reintroduction into carpeting as starting material.

### BRIEF SUMMARY OF THE INVENTION

A carpet recycling method is disclosed according to several embodiments of the present general inventive concept. The carpet recycling method, in certain embodiments, may include, in a toroidal flow pulper, disintegrating carpet in a quantity of liquid to form a slurry of fibrous carpet materials and carpet ash. The carpet recycling method may further include separating at least a portion of the fibrous carpet materials from the slurry, drying the separated fibrous carpet materials, isolating at least a portion of the carpet ash from the slurry, and drying the isolated carpet ash. In several embodiments of the present general inventive concept, a first output comprising dried separated fibrous carpet materials and a second output comprising dried carpet ash are produced, the first and second outputs being suitable for use as starting material in numerous industries.

In certain embodiments of the present general inventive concept, the toroidal flow pulper used in disintegrating the carpet may include a tank sized and shaped to receive the carpet and the quantity of liquid. The toroidal flow pulper may further include a pulper in fluid communication with the tank. In certain embodiments, the pulper may comprise a stationary stator and a rotatable rotor having a plurality of blades defined thereon. The rotor may be nested within and cooperate with the stator to define a reduction and attrition zone therebetween. The rotor may be coupled to a drive shaft, and the drive shaft may be in operable communication with a motor configured to rotate the drive shaft and the rotor. Thus, rotation of the rotor in relation to the stator may operate to shear the carpet while simultaneously drawing the liquid and the carpet into and through the reduction and attrition zone, thereby disintegrating the carpet to form the slurry.

In certain embodiments of the present general inventive concept, the operation of disintegrating carpet is performed by placing the carpet and a the quantity of liquid in the tank of the toroidal flow pulper, rotating the rotor in relation to the stator, pumping the carpet and the liquid through the reduction and attrition zone, thereby shearing the carpet, and recirculating the sheared carpet and the liquid to the tank.

The carpet recycling method may, in some embodiments, further include the operation of packaging the dried separated fibrous carpet materials into transportable units. For example, the operation of packaging the dried separated fibrous carpet materials may, in certain embodiments, be performed by baling the dried separated fibrous carpet materials using a baler.

In certain embodiments of the present general inventive concept, the operation of separating at least a portion of the fibrous carpet materials from the slurry may comprise placing the slurry in a screening chamber defining a series of apertures sized to allow the liquid and the carpet ash to pass through the apertures but to limit the fibrous carpet materials from passing therethrough. Such operation may further comprise agitating the screening chamber and applying additional liquid to an interior of the screening chamber to urge the liquid and the carpet ash through the apertures. The operation of isolating at least a portion of the carpet ash from the slurry may comprise placing the slurry in a hydrocyclone defining a conically-shaped chamber adapted to rotate about a central axis thereof, rotating the chamber of the hydrocyclone, thereby urging circulating separation of the at least one portion of the carpet ash from the liquid of the slurry; and allowing the at least one portion of the carpet ash to fall from a lower portion of the chamber.

In certain embodiments of the present general inventive concept, the operation of drying the isolated carpet ash may be performed by processing the isolated carpet ash through at least one of a vacuum filter and a thermal drying apparatus.

In certain embodiments of the present general inventive concept, at least one of the operations of drying the separated fibrous carpet materials, isolating at least a portion of the carpet ash from the slurry, and drying the isolated carpet ash produces a third output comprising the liquid. In these embodiments, the carpet recycling method may further comprise the operation of directing the third output to the toroidal flow pulper for use in disintegrating additional carpet.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a flow diagram showing one embodiment of a carpet recycling method in accordance with several features of the present general inventive concept;

FIG. 2 is a schematic diagram illustrating several devices useful in performing several embodiments of a carpet recycling method;

FIG. 3 is a cross-sectional view of one embodiment of a toroidal flow pulper useful in performing several embodiments of a carpet recycling method;

FIG. 4 is a partial perspective cutaway view showing the rotor portion of the toroidal flow pulper of FIG. 3;

FIG. 5 is a more detailed flow diagram showing various operations associated with a disintegration operation according to one embodiment of a carpet recycling method in accordance with several features of the present general inventive concept; and

FIG. 6 is detailed flow diagram showing various operations associated with a separation operation according to one embodiment of a carpet recycling method in accordance with several features of the present general inventive concept.

### DETAILED DESCRIPTION OF THE INVENTION

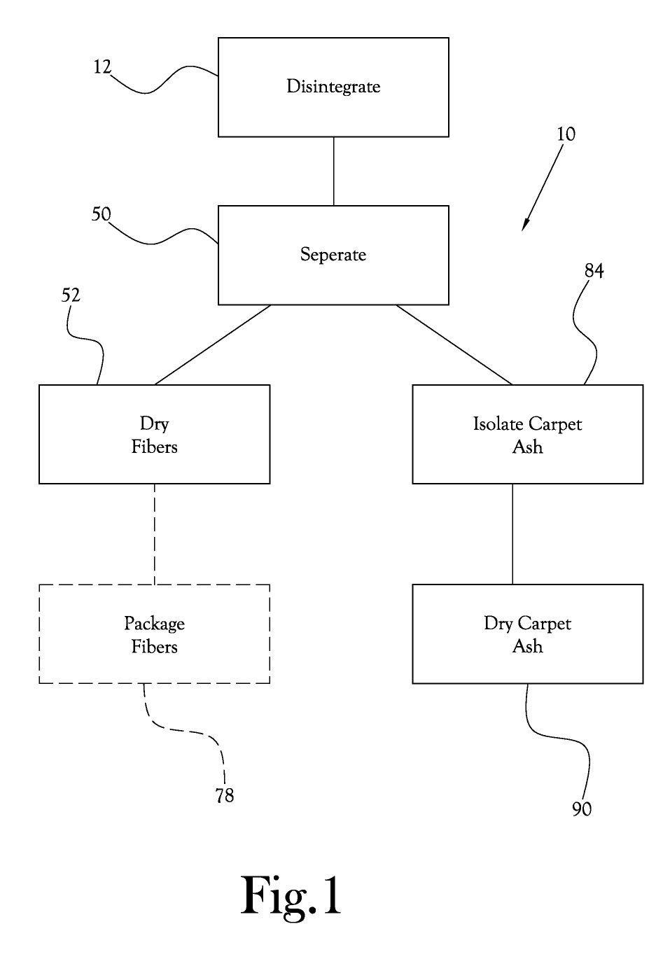

A carpet recycling method, in accordance with several features of the present general inventive concept, is disclosed herein and in the accompanying figures. One embodiment of a carpet recycling method, or method, is shown schematically at 10 in FIG. 1. In the embodiment of FIG. 1, the method 10 begins by disintegrating 12 a carpet, of the type that includes generally a backing comprising carpet ash and a pile comprising mixed carpet fibers, into its constituent carpet fibers, carpet ash, and other constituent materials. As used herein, “carpet fibers” or “mixed carpet fibers” refers to nylon and/or polypropylene fibers that comprise the carpet pile. Further, “carpet ash” refers primarily to the calcium carbonate used in the adhesive that secures the carpet fibers to the carpet backing, as well as to the latex backing itself and any other substances or materials that may settle in the carpet as a result of the normal traffic and wear, such as, for example, dirt and dust particles.

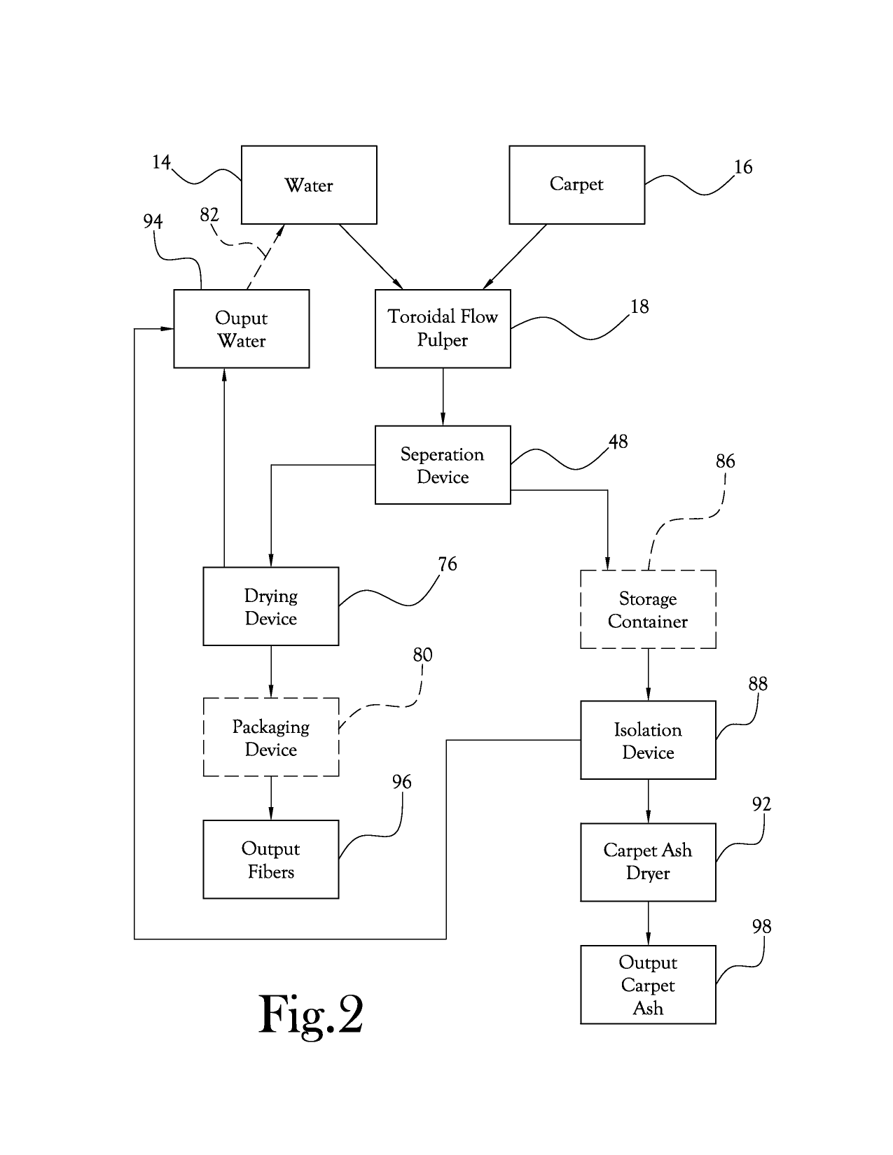

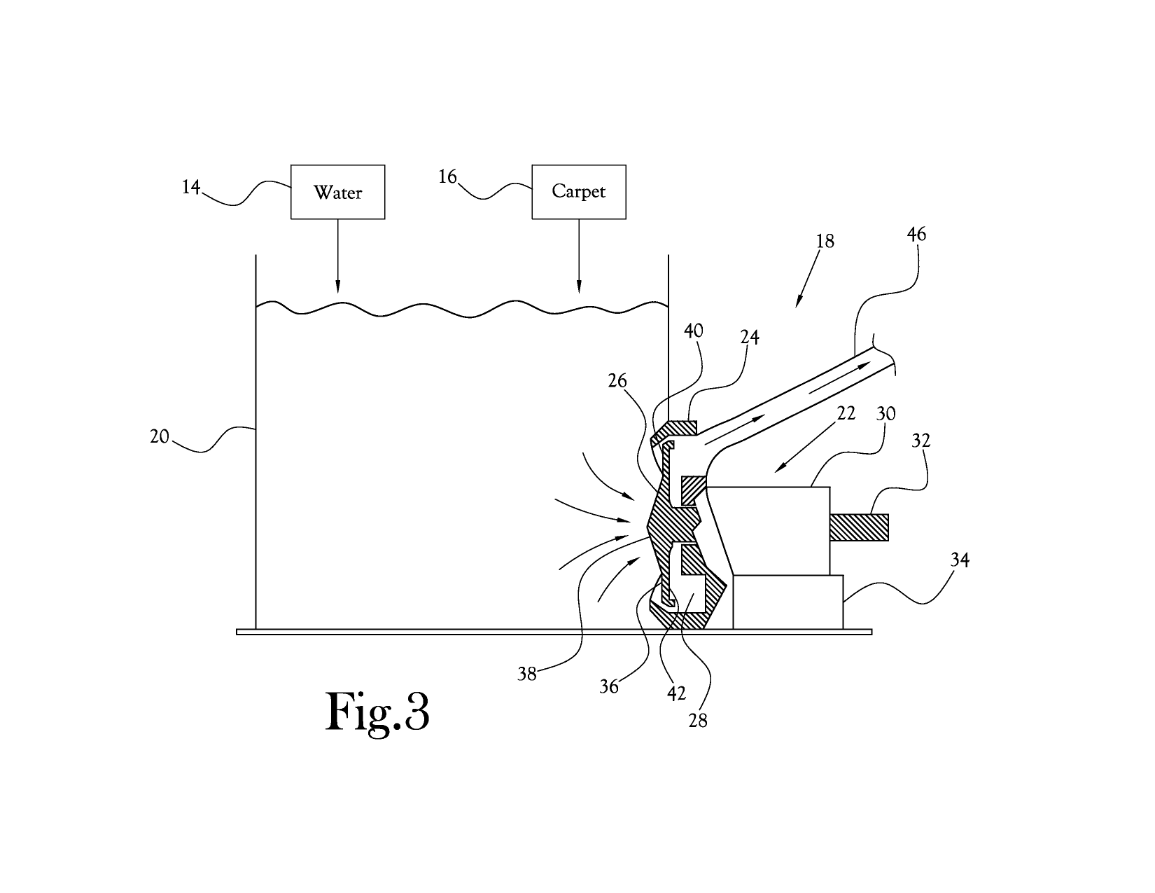

With reference to FIG. 2, in several embodiments, the operation of disintegrating 12 the carpet is performed by processing carpet 16 with an amount of water 14 through a toroidal flow pulper 18. One such toroidal flow pulper 18 that has been used with success is manufactured and sold by Bolton Emerson Americas, LLC and is marketed under the brand name “Tornado.” As shown in FIGS. 3-5, in one embodiment, the toroidal flow pulper 18 comprises generally a tank 20 which is sized and shaped to allow a large volume of water 14 to be placed 56 therein, and into which the carpet 16 may be placed 54. The tank 20 is in fluid communication with a pulper 22 that includes a stationary stator 24 and a nested, rotatable rotor 26 which cooperates with the stator 24 to define a reduction and attrition zone 28 therebetween. A motor 30 is provided to rotate a drive shaft 32, which is in turn coupled to the rotor 26. In several embodiments, a linear translation mechanism 34 is provided to allow selective repositioning of the motor 30, drive shaft 32, and rotor 26 in relation to the stator 24, such that the overall size of the reduction and attrition zone 28 is selectively adjustable.

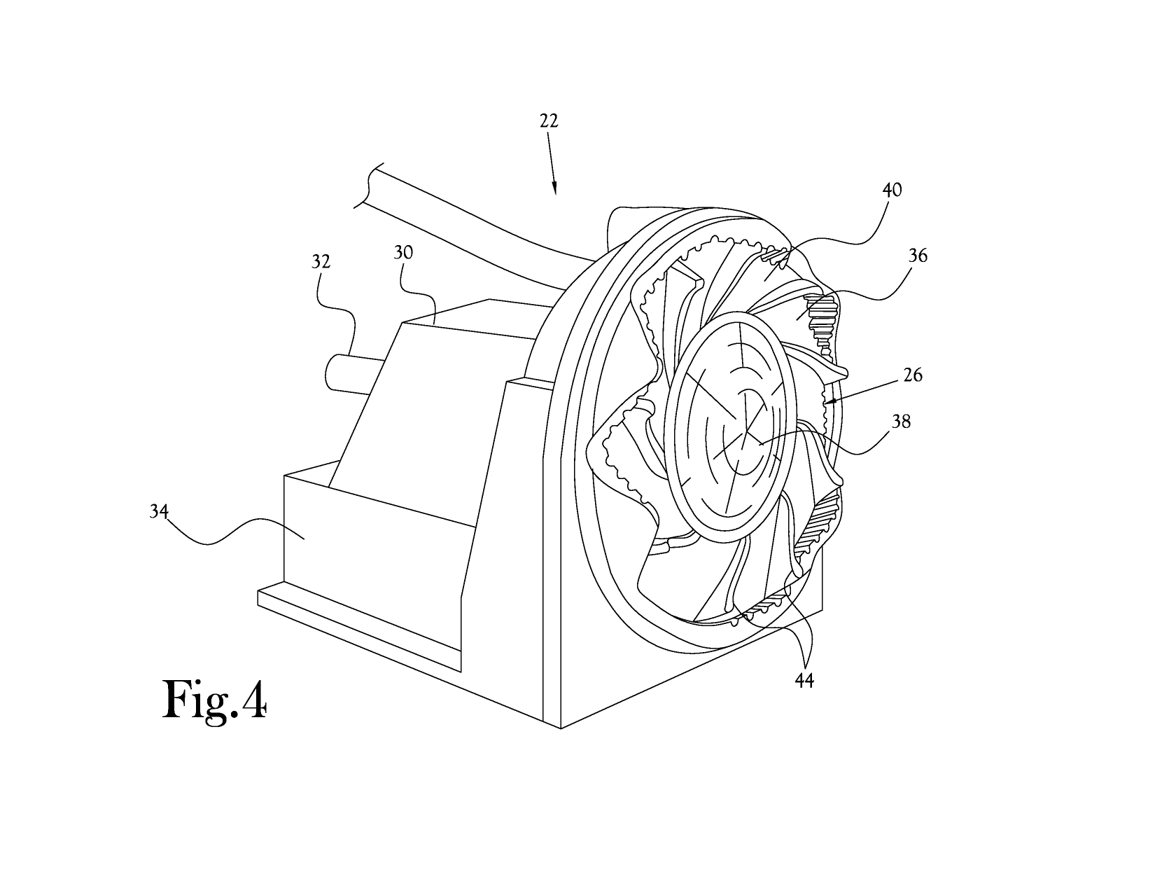

Referring now to FIG. 4, the rotor 26 includes a generally circular plate 36 having a nose cone 38 extending from a central portion of a front surface 40 thereof. The drive shaft 32 is coupled to the circular plate 36 at a central portion of the rear surface 42 thereof. A set of blades 44 are provided in a configuration projecting outwardly from the front surface 40 of the plate 36 and extending generally radially outwardly from the nose cone 38 along the plate front surface 40. In the illustrated embodiment, each of the blades 44 extends along the plate front surface 40 in a generally arced path, such that rotation of the rotor 26 in relation to the stator 24 creates a toroidal flow within the tank 20, thereby agitating the contents of the tank 20, while simultaneously drawing water 16 and carpet 14 into and through the reduction and attrition zone 28.

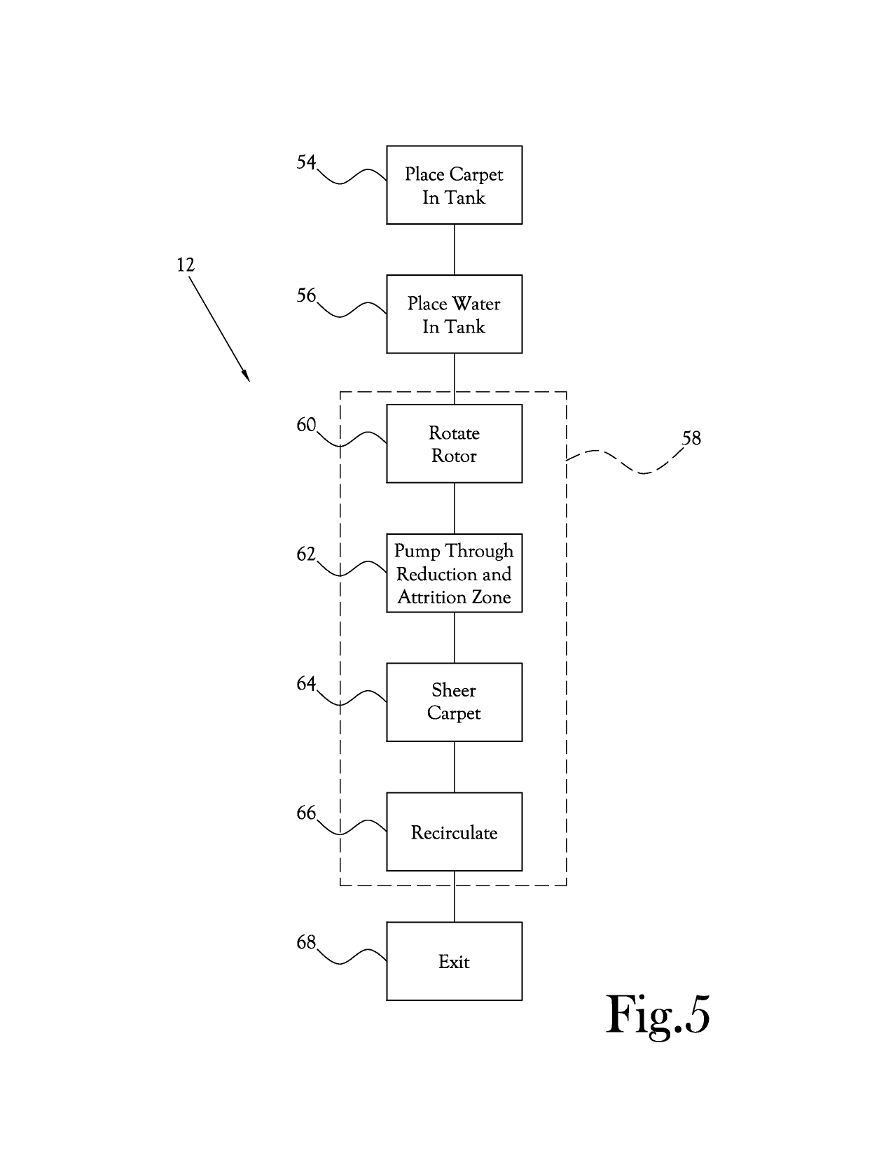

Referring to FIG. 5, in one embodiment of the method 10, the disintegration 12 of the carpet 16 may be accomplished by placing carpet and water, 54, 56 within the tank 20. Thereafter, the motor 30 is activated 58, thereby rotating 60 the rotor 26 in relation to the stator 24 and causing the water 16 and carpet 14 to be pumped 62 through the reduction and attrition zone 28. As water 16 and carpet 14 are pumped 62 into and through the reduction and attrition zone 28 by the rotor 26, the blades 44 interact with a plurality of stator lobes 46 defined in a corresponding circular arrangement by the stator 24 to create a scissoring effect, thereby shearing 64 the carpet 16 into a plurality of pieces. Thereafter, the sheared pieces of carpet 16 and water 14 are recirculated 66 into the tank 20, until such a time as the sheared pieces of carpet 16 and water 14 are permitted to exit 68 the reduction and attrition zone 28 via a conduit 46 (see FIG. 3) which is in fluid communication with the reduction and attrition zone 28.

It will be understood that, whereas certain prior art devices having blade assemblies are not suitable for disintegrating wet carpet, the torodial flow pulper 18 as described above and in the accompanying figures can disintegrate carpet that starts wet or dry into carpet fibers and carpet backing without becoming tangled and jamming. However, it will also be understood by one of skill in the art that the degree to which the carpet 16 is sheared by the toroidal flow pulper 18 may vary depending upon a large number of factors, including but not limited to the relative size of the various components of the toroidal flow pulper 18, the speed at which the rotor 26 rotates in relation to the stator 24, the selected size of the reduction and attrition zone 28, and the number of times the carpet 16 is recirculated through the reduction and attrition zone 28. However, it will generally be recognized that the toroidal flow pulper 18 as described above and in the accompanying figures is capable of dividing carpet into pieces having sizes as large as a few square inches in area, and is also capable of disintegrating the carpet 16 into its component mixed carpet fibers and carpet ash, and is further capable of reducing the size of the fibers themselves. Accordingly, with regard to use of the above-discussed toroidal flow pulper 18 manufactured and sold by Bolton Emerson Americas, LLC and marketed under the brand name “Tornado” to accomplish the disintegration operation 12 of the method 10, in several embodiments of the method 10, such disintegration 12 of the carpet 16 is accomplished by processing the carpet 16 through the toroidal flow pulper 18 for approximately five (5) to ten (10) minutes with the rotor 26 rotating at approximately four hundred thirty (430) rounds per minute. In one embodiment, the carpet 16 is processed through the toroidal flow pulper 18 for six (6) minutes with the rotor 26 rotating at approximately four hundred thirty (430) rounds per minute.

Referring to FIGS. 1 and 2, during the above-described disintegration operation 12, the carpet 16 and water 14 are transformed into a liquid slurry generally comprising water 14, mixed carpet fibers, and carpet ash. More specifically, the various fine particles comprising the carpet ash of the carpet 16 become either dissolved or suspended in the water 14, while the coarser mixed carpet fibers are suspended in the mixture of water 14 and carpet ash. Accordingly, following the operation of disintegrating 12 the carpet, the contents in the toroidal flow pulper 18 are transferred to a separation device 48 for separation 50 of the mixed carpet fibers from the mixture of water 14 and carpet ash.

The separation device 48 may include one or more of any of a variety of known devices which are suitable to accomplish separation 50 of the mixed carpet fibers from the mixture of water 14 and carpet ash, including but not limited to various types of liquid presses, such as for example a belt press, a filtration device, a screening device, or the like. For example, in several embodiments, the separation device 48 is provided by a screening device. However, it is not the intention of the applicant to limit the method 10 of the present general inventive concept to use of any particular type of device to accomplish separation 50 of the mixed carpet fibers from the mixture of water 14 and carpet ash.

In some embodiments, the separation device 48 is provided by a screening device which includes generally a screening chamber that is lined with a series of apertures sized to separate the carpet fibers from the carpet ash. It will be recognized that the particular aperture sizes can vary without departing from the scope or spirit of the present general inventive concept. However, it will be understood that the apertures are generally sized to substantially retain the carpet fibers within the screening chamber while permitting smaller particles and liquid to pass therethrough. For example, in one embodiment, the apertures defined by the screening chamber are each sized to approximately one (1) micron.

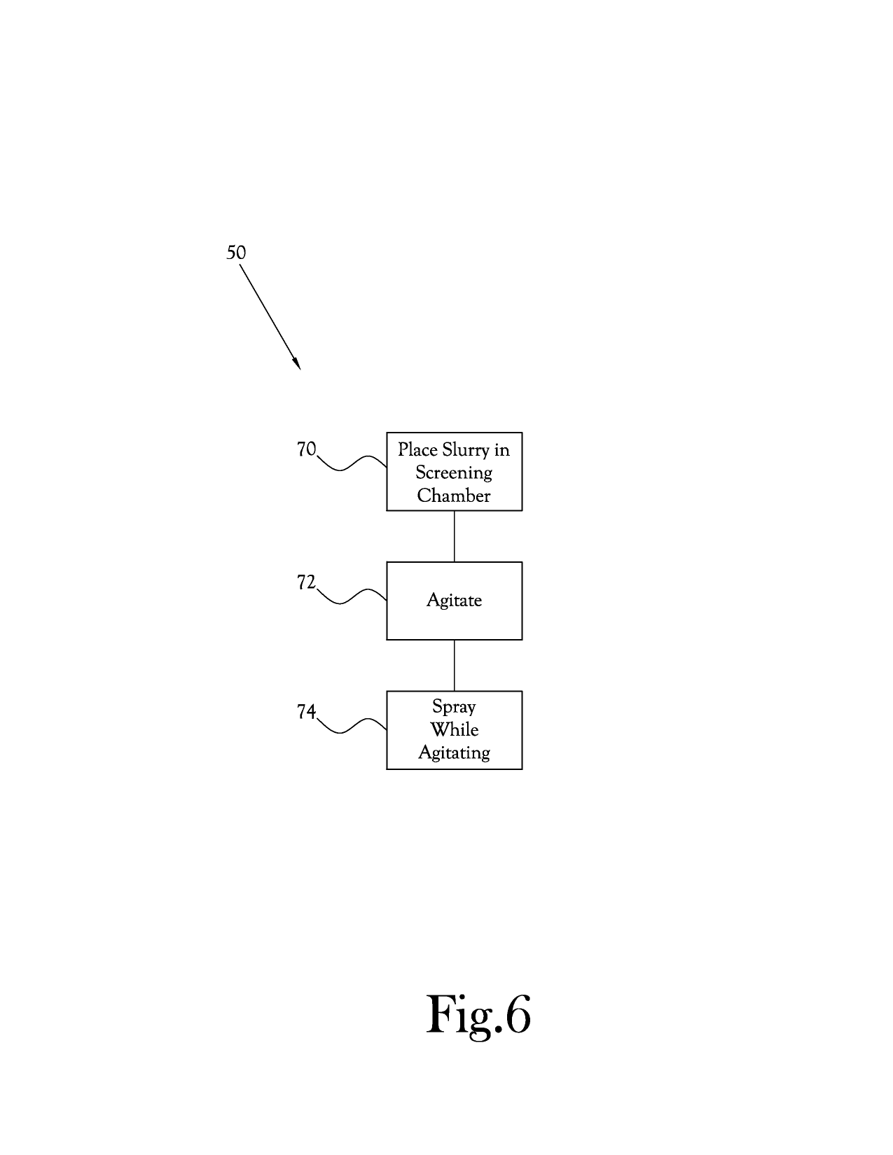

Referring to FIG. 6, in one embodiment, the separation operation 50 includes placing 70 the liquid slurry of mixed carpet fibers, water, and carpet ash within the screening chamber, which is then rotated or otherwise agitated 72 while additional water is sprayed 74 inside. The agitation 72 of the screening chamber together with the additional water spray serves to clean the carpet fibers and force the accompanying water and carpet ash to pass through the apertures defined in the screening chamber, leaving the mixed carpet fibers within the inner screening chamber. In the embodiment of FIG. 6, the agitation 72 of the screening chamber is illustrated as occurring prior to the operation of spraying 74 additional water into the screening chamber. However, it will be understood that the operations of agitation 72 and spraying 74 may occur in any order, and may also occur simultaneously, without departing from the spirit and scope of the present general inventive concept.

It will further be recognized that, depending upon the type of device utilized in the separation operation 50, following the separation operation 50, the carpet fibers may still retain a significant moisture content, sometimes as much as ninety (90) percent by weight. Accordingly, and with reference again to FIGS. 1 and 2, following the operation of separation 50 of the mixed carpet fibers from the mixture of water 14 and carpet ash, the mixed carpet fibers are further dried 52. In some embodiments of the present invention, the mixed carpet fibers are transferred from the separation device 48 to a drying device 76 in order to release the moisture content still contained within the fibrous carpet materials. In one embodiment, the drying device 76 is provided by a basket centrifuge. However, it will be understood that numerous other devices are suitable for providing the drying device 76, and such devices may be used without departing from the present general inventive concept. In one embodiment in which the drying device 76 is a basket centrifuge, the basket centrifuge spins the fibrous carpet materials in order to separate water from the fibrous carpet materials by density. Specifically, the moisture-bearing fibrous materials are spun in the basket centrifuge such that the moisture is urged to the bottom of the basket centrifuge and the less-dense fibrous materials collect near the top of the basket centrifuge.

It will be understood that, in certain embodiments, the drying device 76, in addition to producing dried mixed carpet fibers, produces an output of water 94 separated from the mixed carpet fibers. In some embodiments, the outputted water separated from the carpet fibers by the drying device 76 may be optionally directed 82 back for additional use in the toroidal flow pulper 18. However, it will be understood that such optional direction 82 of the outputted water 94 is not necessary to accomplish the present general inventive concept.

In an optional step following the operation of drying 52 the fibrous carpet materials, the dried carpet fibers are packaged 78 into transportable units. In some embodiments of the present invention, the mixed carpet fibers are collected from the drying device 76 and transferred to a suitable packaging device 80, such as for example a compacting apparatus. In some embodiments, a bailer (not shown) is utilized whereby a collection of mixed carpet fibers are placed in a compacting zone where a compacting member compresses the carpet fibers into a bale that can be circumferentially tied and easily loaded onto a pallet or like transporting unit. In their compacted state, the mixed carpet fibers, can then be easily transported for further use, such as for example for use as starting material in various industries. In any case, following drying 52 of the mixed carpet fibers, an output 96 of dried mixed carpet fibers is produced.

Returning to FIG. 1, in several embodiments of the present general inventive concept, the mixture of water and carpet ash separated 50 from the carpet fibers by the separation device 48 is further processed 84 to isolate the carpet ash from the water in the mixture. For example, in some embodiments, such as the embodiment of FIG. 2, the mixture is optionally transferred and stored in a storage container 86 until enough has accumulated for further processing. Thereafter, the water and carpet ash mixture can be transported via pump or other suitable transportation device to an isolation device 88, such as for example a hydrocyclone or other such device suitable for isolating the carpet ash from the water in the mixture. Upon receiving the water and carpet ash mixture, the isolation device 88 separates the carpet ash particles from the water in the mixture.

In several embodiments, the isolation device 88 is provided by a hydrocyclone which includes a conically-shaped container which is adapted to spin about a central axis of the conically-shaped container, such that upon receiving the mixture, such spinning of the hydrocyclone encourages circulating separation of the carpet ash from the liquid. More specifically, because the carpet ash in the mixture has a density greater than water, spinning of the hydrocyclone encourages the carpet ash to fall through the bottom of the hydrocyclone while the water in the mixture is retained therein. In several embodiments, the state of the carpet ash falling through the bottom of the hydrocyclone is a moist solid. Thus, it will be understood that, while the hydrocyclone serves to isolate the solid particles from a portion of the water in the mixture, the solid particles may contain a certain quantity of moisture.

Referring again to FIG. 2, just as the drying device 76 may contribute to an output of water 94 separated from the carpet fibers by the drying device 76, and just as such output water 94 may optionally be recycled 82 back to the toroidal flow pulper 18, the additional water isolated 84 from the carpet ash in the isolation device 88 can also be optionally be collected as output water 94 and transferred 82 back to the toroidal flow pulper 18 for use in additional disintegration of carpet. However, as discussed above, such recycling 82 of the output water 94 from either the drying device 76 or the isolation device 88 is not necessary in order to accomplish the method 10 of the present general inventive concept.

After isolating the carpet ash 84, the carpet ash is dried 90 in order to purge it of any remaining moisture. Thus, an output of dried carpet ash 98 is produced. In some embodiments, the primarily-solid carpet ash that is isolated 84 by the isolation device 88 is then transferred to a carpet ash dryer 92, such as for example a rotary vacuum filter. The rotary vacuum filter filters the semi-solid mixture by rotating an apertured drum inside of a housing. Washing water is introduced to clean the semi-solid mixture which is urged by a vacuum force against the exterior of the rotating drum, within the housing. The liquid accompanying the solid carpet ash, as well as the washing water introduced inside the housing, is sucked through the apertured, rotating drum, leaving only solid particles adhered against the exterior of the apertured drum. The solid ash may then be preserved while the water may be collected as output water and recycled back to the toroidal flow pulper 18 as discussed above. In one embodiment, after processing the carpet ash through the rotary vacuum filter as discussed above, the carpet ash is then sent to a thermal drying apparatus where electric heat and air cooperate to create a blow-drying effect that is applied directly to the carpet ash. However, numerous suitable devices and configurations for drying 90 the carpet ash to create the output of dried carpet ash 98 will be readily apparent to one of suitable skill in the art, and such other devices and configurations may be used without departing from the spirit and scope of the present general inventive concept.

From the foregoing, it will be recognized that a carpet recycling method has been provided in accordance with various embodiments of the present general inventive concept. Specifically, the carpet recycling process enables a user to recycle carpet pieces and harvest at least two outputs, namely, an output of mixed carpet fibers and an output of predominantly calcium carbonate carpet ash. In several embodiments, the mixed carpet fibers recovered by the carpet recycling method disclosed herein contain an ash content that is less than five (5) percent, which presents a significant improvement over other known carpet recycling methods.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A carpet recycling method comprising the steps of:
in a toroidal flow pulper, disintegrating carpet in a quantity of liquid to form a slurry of fibrous carpet materials and carpet ash;
separating at least a portion of said fibrous carpet materials from said slurry;
drying said separated fibrous carpet materials;
isolating at least a portion of said carpet ash from said slurry; and
drying said isolated carpet ash;
whereby a first output comprising dried separated fibrous carpet materials and a second output comprising dried carpet ash are produced.

2. The method of claim 1, wherein said toroidal flow pulper comprises:
a tank sized and shaped to receive said carpet and said quantity of liquid; and
a pulper in fluid communication with said tank.

3. The method of claim 2, wherein said pulper further comprises:
a stationary stator; and
a rotatable rotor having a plurality of blades defined thereon, said rotor being nested within and cooperating with said stator to define a reduction and attrition zone therebetween, said rotor being coupled to a drive shaft, said drive shaft being in operable communication with a motor configured to rotate said drive shaft and said rotor;
whereby rotation of said rotor in relation to said stator operates to shear said carpet while simultaneously drawing said liquid and said carpet into and through said reduction and attrition zone, thereby disintegrating said carpet to form said slurry.

4. The method of claim 3, said operation of disintegrating carpet being performed by:
placing said carpet and said quantity of liquid in said tank of said toroidal flow pulper;
rotating said rotor in relation to said stator;
pumping said carpet and said liquid through said reduction and attrition zone, thereby shearing said carpet; and
recirculating said sheared carpet and said liquid to said tank.

5. The method of claim 4 further including the operation of packaging said dried separated fibrous carpet materials into transportable units.

6. The method of claim 5, said operation of packaging said dried separated fibrous carpet materials being performed by baling said dried separated fibrous carpet materials using a baler.

7. The method of claim 6, said operation of separating at least a portion of said fibrous carpet materials from said slurry comprising:
placing said slurry in a screening chamber defining a series of apertures sized to allow said liquid and said carpet ash to pass through said apertures but to limit said fibrous carpet materials from passing therethrough;
agitating said screening chamber; and
applying additional liquid to an interior of said screening chamber to urge said liquid and said carpet ash through said apertures.

8. The method of claim 7, said operation of isolating at least a portion of said carpet ash from said slurry comprising:
placing said slurry in a hydrocyclone defining a conically-shaped chamber adapted to rotate about a central axis thereof;
rotating said chamber of said hydrocyclone, thereby urging circulating separation of said at least one portion of said carpet ash from said liquid of said slurry; and
allowing said at least one portion of said carpet ash to fall from a lower portion of said chamber.

9. The method of claim 8, said operation of drying said isolated carpet ash being performed by processing said isolated carpet ash through at least one of a vacuum filter and a thermal drying apparatus.

10. The method of claim 9 wherein at least one of said operations of drying said separated fibrous carpet materials, isolating at least a portion of said carpet ash from said slurry, and drying said isolated carpet ash produces a third output comprising said liquid, said method further comprising the operation of directing said third output to said toroidal flow pulper for use in disintegrating additional carpet.

11. A method for separating carpet into constituent components comprising the steps of:
providing a toroidal flow pulper having a tank sized and shaped to receive said carpet and a quantity of liquid and a pulper in fluid communication with said tank, said pulper having a stationary stator and a rotatable rotor having a plurality of blades defined thereon, said rotor being nested within and cooperating with said stator to define a reduction and attrition zone therebetween, said rotor being coupled to a drive shaft, said drive shaft being in operable communication with a motor configured to rotate said drive shaft and said rotor;
placing said carpet and said quantity of liquid in said a tank; and
rotating a rotor of said toroidal flow pulper in relation to said stator;
whereby rotation of said rotor in relation to said stator operates to shear said carpet while simultaneously drawing said liquid and said carpet into and through said reduction and attrition zone, thereby disintegrating said carpet to form a slurry.

12. The method of claim 11 further comprising the operation of pumping said carpet and said liquid through said reduction and attrition zone, thereby shearing said carpet.

13. The method of claim 12 further comprising the operation of recirculating said sheared carpet and said liquid to said tank.

14. The method of claim 13 further comprising the operation of pumping said sheared carpet and said liquid to a location outside said toroidal flow pulper for separation of said sheared carpet from said liquid.

15. A method for separating carpet into constituent components comprising the steps of:
providing a toroidal flow pulper having a tank sized and shaped to receive said carpet and a quantity of liquid and a pulper in fluid communication with said tank, said pulper having a stationary stator and a rotatable rotor having a plurality of blades defined thereon, said rotor being nested within and cooperating with said stator to define a reduction and attrition zone therebetween, said rotor being coupled to a drive shaft, said drive shaft being in operable communication with a motor configured to rotate said drive shaft and said rotor;
placing said carpet and said quantity of liquid in said a tank;
rotating a rotor of said toroidal flow pulper in relation to said stator;
pumping said carpet and said liquid through said reduction and attrition zone, thereby shearing said carpet;
recirculating said sheared carpet and said liquid to said tank; and
pumping said sheared carpet and said liquid to a location outside said toroidal flow pulper for separation of said sheared carpet from said liquid;
whereby rotation of said rotor in relation to said stator operates to shear said carpet while simultaneously drawing said liquid and said carpet into and through said reduction and attrition zone, thereby disintegrating said carpet to form a slurry.
